(19) United States
(12) Patent Application Publication
(10) Pub. No.: US 2005/0207429 A1
(43) Pub. Date: Sep. 22, 2005

(54) Home agent duplication method and home agent duplication apparatus

(76) Inventors: Kenichi Akita, Osaka (JP); Yamato Sakurai, Osaka (JP); Junji Takezaki, Osaka (JP); Makoto Nagaki, Osaka (JP); Koujirou Seto, Osaka (JP); Futoshi Nakamori, Osaka (JP)

Correspondence Address: KATTEN MUCHIN ROSENMAN LLP, 575 MADISON AVENUE, NEW YORK, NY, 10022-2585, US

(21) Appl. No.: 10/946,976

(22) Filed: Sep. 22, 2004

(30) Foreign Application Priority Data
Mar. 17, 2004 (JP) 2004-076624

(51) Int. Cl. H04Q 7/00

(52) U.S. Cl. 370/401

(57) ABSTRACT

A method for duplicating a home agent including an address correspondence maintaining unit for maintaining a destination address of a mobile terminal in correspondence with a home address of the mobile terminal, and a transferring unit for encapsulating an IP packet addressed to the home address of the mobile terminal and transferring the encapsulated IP packet to the destination address of the mobile terminal is disclosed. The method includes the steps of setting a home agent address, which is the same as a home agent address of an operation system home agent, to a standby system home agent, and receiving a location registration request, which is sent from the mobile terminal and addressed to the operation system home agent, with the standby system home agent.

### BACKGROUND OF THE INVENTION

1. Field of the Invention

The present invention generally relates to a home agent duplication method and a home agent duplication apparatus, and more particularly, to a home agent duplication method and a home agent duplication apparatus for improving reliability of a home agent.

2. Description of the Related Art

In recent mobile communication network technology research and development, research and development are conducted on mobile IP (Internet Protocol) technology of a fourth generation network for achieving mobility throughout the entire IP network. In realizing such mobile IP, a home agent, which manages IP addresses assigned to destinations of mobile terminals (MN) and transfers packets addressed to the IP addresses, plays a vital role. Accordingly, in order to maintain and improve reliability and convenience of the mobile IP, enhancement in the reliability of the home agent is necessary.

FIG. 1 is a block diagram showing an exemplary configuration of a conventional mobile IP (mobile IPv4). In FIG. 1, a mobile terminal(s) (MN) 10 has a predetermined home address (HoA), and is usually connected to a home link 11 such a company LAN. A router (RT), and home agents (HA) 13, 14 are connected to the home link 11. Further, the router 12 is connected to a network 15, such as the Internet.

The home agents 13, 14 have an IP in IP function, in which the home agents 13, 14 encapsulate a binding cache (BC), which holds a destination address (care of address: CoA) of the mobile terminal 10 in correspondence with a home address (HoA) of the mobile terminal 10, and transferred IP packets addressed to the home address of the mobile terminal 10, and transfer the encapsulated data.

Next, an operation of the mobile IP is described.
(1) The mobile terminal 10 moves from the home link 11 and connects to the network 15 via an external link 16.
(2) The mobile terminal 10 delivers a home agent search packet to the home link 11.
(3) When the home agents 13, 14 situated on the home link 11 receive the home agent search packet, the home agents 13, 14 returns a home agent search response including its own predetermined IP address to the mobile terminal 10.
(4) The mobile terminal 10 selects the most suitable home agent 13 or 14 (in this example, home agent 13) according to the received home agent search response, and conducts location registration.
(5) The home agent 13 transfers data, which is addressed to the mobile terminal 10, from a communication destination terminal (CN) 17 to the mobile terminal 10.

Accordingly, with the above-described conventional mobile IP technology, an available home agent (in this example, home agent 13) can be notified to the mobile terminal 10 by allowing one of the home agents 13, or 14 situated at the home link 11 to respond to the home agent search packet delivered from the mobile terminal 10.

That is, the home link 11 side is able to select the available home agent 13 and notify the selected available home agent 13 to the mobile terminal 10, to thereby allow the mobile terminal to select the most suitable home agent 13 according to the state of the home link 11.

The conventional technology is a technology for selecting an available home agent, and serves to improve reliability by dispersing the load of the home agent. However, in a case where a disorder occurs in the home agent, location information of the mobile terminal becomes lost, and data transfer is stopped.

Cluster technology may be employed for solving this problem, in which a plurality of home agents 14a, 14b logically posing to be a single home agent 14 are used. However, the employment of this technology has a problem of requiring expensive hardware and software.

Meanwhile, in an example shown in Japanese Laid-Open Patent Application No.10-512122, hardware and data redundancy are provided to a database including a location register maintained in a mobile switching center of a mobile telephone system.

Further, in an example shown in Japanese Laid-Open Patent Application No.2000-152315, a common line signal technique is employed for enhancing reliability of a health checkup, and an example shown in Japanese Laid-Open Patent Application No. 11-68780 serves to a solve problem(s) caused when applying a mobile IP technology to an ATM network.

However, with the conventional mobile IP technology, data transfer to a mobile terminal is obstructed whenever there is a disorder in the home agent since location information managed by the home agent is erased from the network.

Although cluster technology, which physically uses plural apparatuses as home agents, may be applied in solving the problem, the employment of this technology requires expensive hardware and software, to thereby result to an increase the cost of plant and equipment investment for companies and communication businesses.

### SUMMARY OF THE INVENTION

It is a general object of the present invention to provide a home agent duplication method and a home agent duplication apparatus that substantially obviates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a home agent duplication method and a home agent duplication apparatus particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides a method for duplicating a home agent including an address correspondence maintaining unit for maintaining a destination address of a mobile terminal in correspondence with a home address of the mobile terminal, and a transferring unit for encapsulating an IP packet addressed to the home address of the mobile terminal and transferring the encapsulated IP packet to the destination address of the mobile terminal, the method including the steps of: setting a home agent address, which is the same as a home agent address of an operation system home agent, to a standby system home agent; and receiving a location registration request, which is sent from the mobile terminal and addressed to the operation system home agent, with the standby system home agent.

The home agent duplication method according to an embodiment of the present invention may further include the steps of: generating a corresponding relation between the destination address of the mobile terminal and the home address of the mobile terminal with the standby system home agent, the generated corresponding relation having the same content as the corresponding relation of the operation system home agent; maintaining the generated corresponding relation in an address correspondence maintaining unit of the standby system home agent; and returning no response from the standby system home agent with respect to the location registration request sent from the mobile terminal.

The home agent duplication method according to the present invention may further include a step of: periodically transmitting location registration requests registered in an address correspondence maintaining unit of the operation system home agent to the standby system home agent.

The home agent duplication method according to the present invention may further include the steps of: monitoring an operation state of the operation system home agent; and switching a transmission destination from the operation system home agent to the standby system home agent when a disorder of the operation system home agent is detected from monitoring the operation state of the operation system home agent, so that packets addressed to the home address and the operation system home agent are transferred to the standby system home agent.

The home agent duplication method according to the present invention may further include the steps of: transmitting location registration requests registered in the address correspondence maintaining unit of the standby system home agent to the operation system home agent when a recovery of the disorder of the operation system home agent is detected from monitoring the operation state of the operation system home agent; generating another corresponding relation between the destination address of the mobile terminal and the home address of the mobile terminal with the operation system home agent, the other generated corresponding relation having the same content as the corresponding relation of the standby system home agent; maintaining the generated corresponding relation in the address correspondence maintaining unit of the standby system home agent; and returning no response from the operation system home agent with respect to the location registration request sent from the mobile terminal.

The home agent duplication method according to the present invention may further include a step of: switching a transmission destination from the standby system home agent to the operation system home agent when completing the transmission of the location registration requests from the standby system home agent to the operation system home agent after detecting the recovery of the disorder of the operation system home agent, so that packets addressed to the home address and the operation system home agent are transferred to the operation system home agent.

The home agent duplication method according to the present invention may further include a step of: setting another home agent address, which is the same as another home agent address of another operation system home agent, to the standby system home agent.

Furthermore, the present invention provides a standby system home agent used for a method for duplicating a home agent including an address correspondence maintaining unit for maintaining a destination address of a mobile terminal in correspondence with a home address of the mobile terminal, and a transferring unit for encapsulating an IP packet addressed to the home address of the mobile terminal and transferring the encapsulated IP packet to the destination address of the mobile terminal, the standby system home agent including: a home agent address maintaining unit for maintaining a home agent address which is the same as a home agent of an operation system agent, wherein the standby system home agent receives a location registration request which is sent from the mobile terminal and addressed to the operation system home agent.

The standby system home agent according to an embodiment of the present invention may further include a no response unit for generating a corresponding relation between the destination address of the mobile terminal and the home address of the mobile terminal, the generated corresponding relation having the same content as the corresponding relation of the operation system home agent, for maintaining the generated corresponding relation in an address correspondence maintaining unit of the standby system home agent, and for returning no response with respect to the location registration request sent from the mobile terminal.

The standby system home agent according to an embodiment of the present invention may further include a switching unit for switching a transmission destination from the operation system home agent to the standby system home agent when a disorder of the operation system home agent is detected from monitoring an operation state of the operation system home agent, so that packets addressed to the home address and the operation system home agent are transferred to the standby system home agent.

The standby system home agent according to an embodiment of the present invention may further include a transmitting unit for transmitting location registration requests registered in the address correspondence maintaining unit of the standby system home agent to the operation system home agent when a recovery of the disorder of the operation system home agent is detected from monitoring the operation state of the operation system home agent.

In the standby system home agent according to an embodiment of the present invention, the switching unit switches a transmission destination from the standby system home agent to the operation system home agent when completing the transmission of the location registration requests from the standby system home agent to the operation system home agent after detecting the recovery of the disorder of the operation system home agent, so that packets addressed to the home address and the operation system home agent are transferred to the operation system home agent.

Furthermore, the present invention provides an operation system home agent used for a method for duplicating a home agent including an address correspondence maintaining unit for maintaining a destination address of a mobile terminal in correspondence with a home address of the mobile terminal, and a transferring unit for encapsulating an IP packet addressed to the home address of the mobile terminal and transferring the encapsulated IP packet to the destination address of the mobile terminal, the operation system home agent including: a transmitting unit for periodically transmitting location registration requests registered in an address correspondence maintaining unit of the operation system home agent to the standby system home agent.

The operation system home agent according to an embodiment of the present invention may further include a no response unit for receiving location registration requests registered in the address correspondence maintaining unit of the standby system home agent from the standby system home agent, for generating a corresponding relation between the destination address of the mobile terminal and the home address of the mobile terminal, the generated corresponding relation having the same content as the corresponding relation of the standby system home agent, for maintaining the generated corresponding relation in the address correspondence maintaining unit of the standby system home agent, and for returning no response with respect to the location registration request sent from the mobile terminal.

Other objects and further features of the present invention will be apparent from the following detailed description when read in conjunction with the accompanying drawings.

### BRIEF DESCRIPTION OF THE DRAWINGS

FIG. 1 is a block diagram showing an exemplary configuration of a conventional mobile IP;

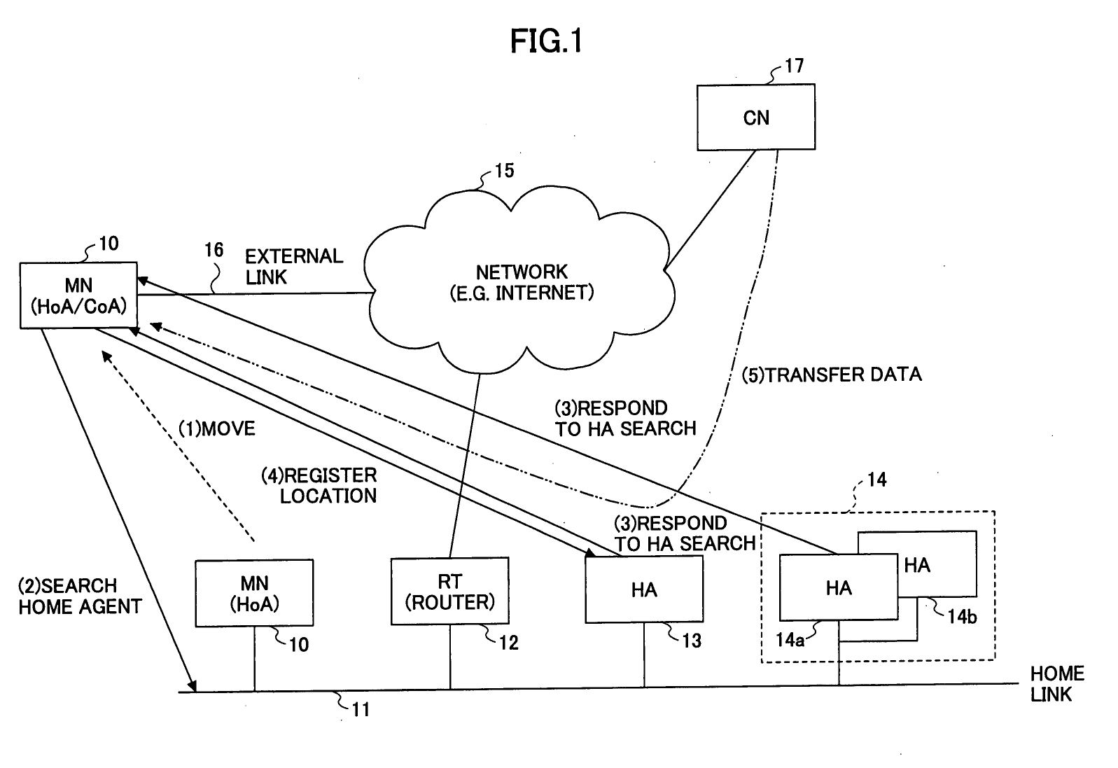

FIG. 2 is a block diagram showing a system being applied with a home agent duplication method according to an embodiment of the present invention;

FIG. 3 is a block diagram showing a standby system home agent according to an embodiment of the present invention;

FIG. 4 is a block diagram showing an operation system home agent according to an embodiment of the present invention;

FIG. 5 is a flowchart showing a process executed by a packet control part according to an embodiment of the present invention;

FIG. 6 is a flowchart for describing an extended address resolution function according to an embodiment of the present invention;

FIG. 7 is a flowchart for describing a system switching control function according to an embodiment of the present invention;

FIG. 8 is a flowchart for describing a mobile IP control protocol transfer function according to an embodiment of the present invention;

FIG. 9 is a flowchart for describing a mobile IP control information retransmission function according to an embodiment of the present invention;

FIG. 10 is a flowchart for describing a mobile IP control protocol reception standby function according to an embodiment of the present invention;

FIG. 11 is a flowchart for describing a mobile IP control binding cache recovery function according to an embodiment of the present invention;

FIG. 12 is a flowchart for describing a mobile IP control binding cache recovery monitor function according to an embodiment of the present invention;

FIG. 13 is a flowchart for describing a disorder monitor packet transmission function according to an embodiment of the present invention;

FIG. 14 is a flowchart for describing a disorder monitor packet reception function according to an embodiment of the present invention;

FIG. 15 is a flowchart for describing a disorder monitor timer control function according to an embodiment of the present invention;

FIG. 16 is a schematic diagram showing an operation sequence for determining between operation system and standby system upon activation of the home agent according to an embodiment of the present invention;

FIG. 17 is a schematic diagram showing an operation sequences in a case where an operation system home agent receives a location registration request from a mobile terminal according to an embodiment of the present invention;

FIG. 18 is a schematic diagram showing an operation sequences in a case where an operation system home agent receives a location registration request from a mobile terminal according to an embodiment of the present invention;

FIG. 19 is a schematic diagram showing an operation sequence for conforming the binding cache of the operation system home agent and that of the standby system home agent according to an embodiment of the present invention;

FIG. 20 is a schematic diagram showing a case where there is a disorder in the operation system according to an embodiment of the present invention;

FIG. 21 is a schematic diagram showing operation sequence in a case where the operation system recovers from disorder according to an embodiment of the present invention;

FIG. 22 is a schematic diagram showing operation sequence in a case where the operation system recovers from disorder according to an embodiment of the present invention; and

FIG. 23 is a schematic diagram showing an operation sequence in a case where a single standby system is provided with respect to plural operation systems.

### DESCRIPTION OF THE PREFERRED EMBODIMENTS

In the following, embodiments of the present invention will be described with reference to the accompanying drawings.

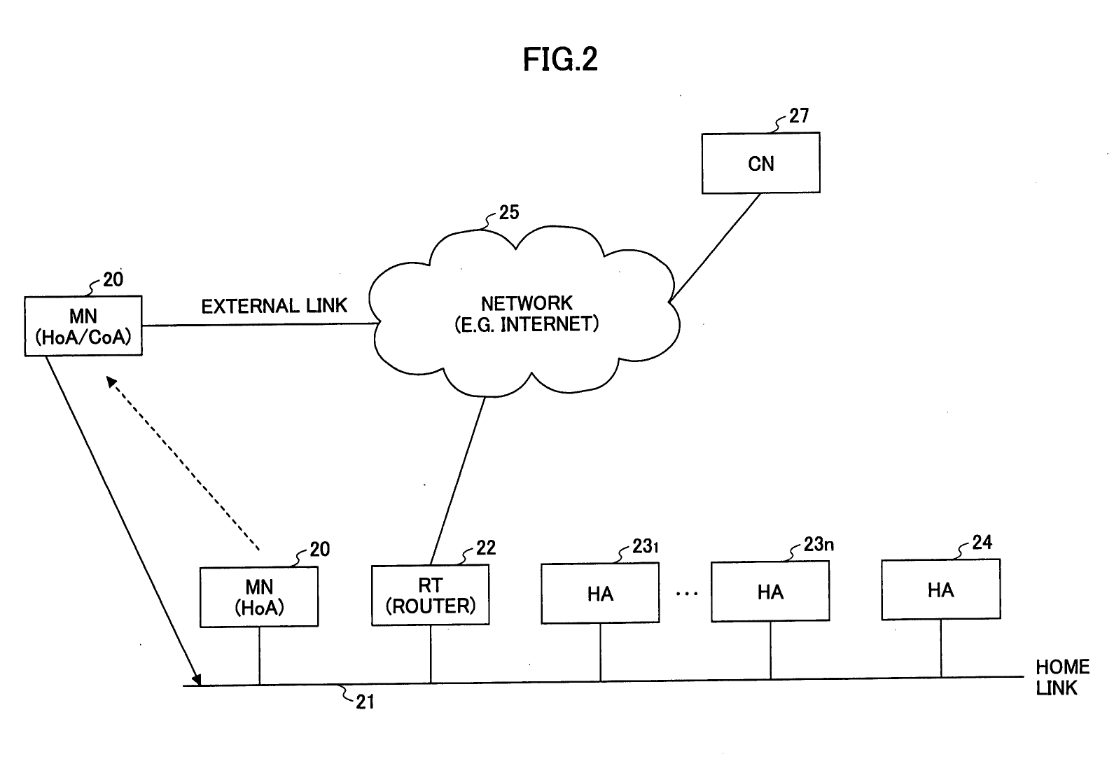

FIG. 2 is a block diagram showing an exemplary system being applied with a home agent duplication method according to an embodiment of the present invention. In FIG. 2, a mobile terminal (MN) 20 has a predetermined home address (HoA), and is normally connected to a home link 21, such as a company LAN. The home link 21 is connected to a router (RT) 22, an operation system home agent(s) (HA) 23₁˜23ₙ and a standby system home agent (HA) 24. The router 22 is connected to a network 25 (e.g. the Internet). The network 25 is connected to, for example, the moved mobile terminal 20 and a communication destination terminal (CN) 27. It is to be noted that n numbers of operation system home agents are not required, but a single operation system home agent may alternatively be employed.

The home agent 23₁˜23ₙ, 24 have an IP in IP function, in which the home agents 23₁˜23_{w}, 24 encapsulate a binding cache (BC), which holds a move destination address (care of address: CoA) of the mobile terminal 20 in correspondence with a home address (HoA) of the mobile terminal 20, and transferred IP packets addressed to the home address of the mobile terminal 20, and transfer the encapsulated data to the care of address (CoA).

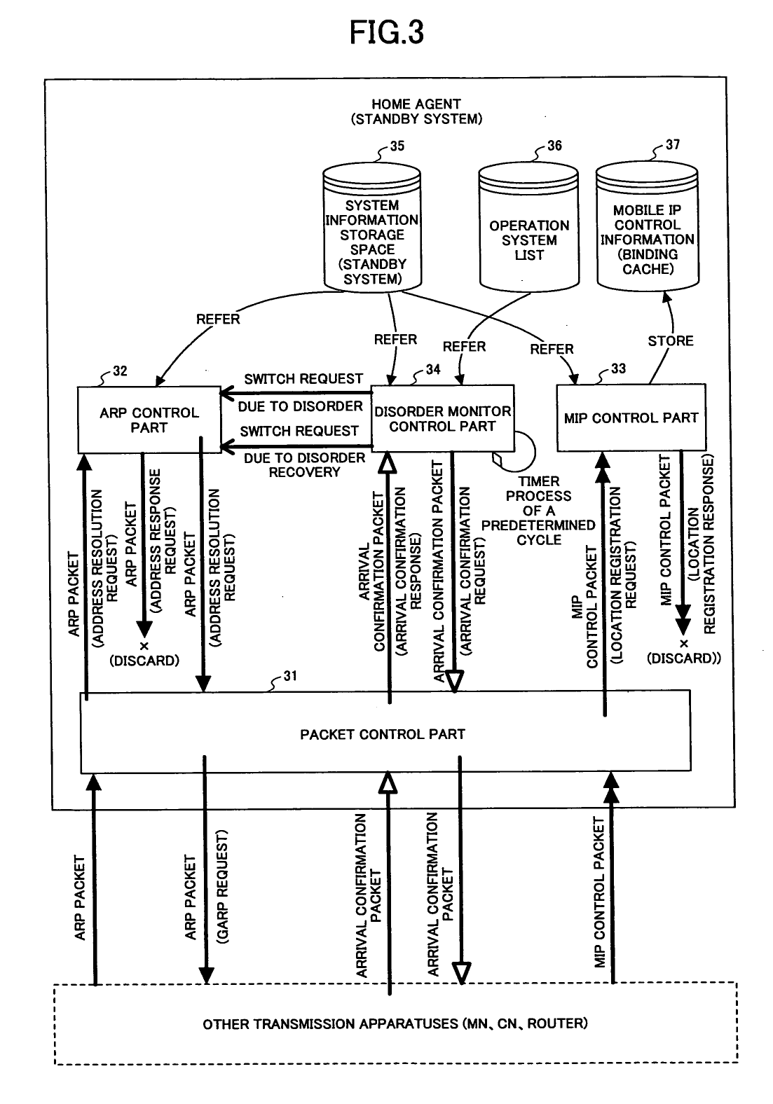

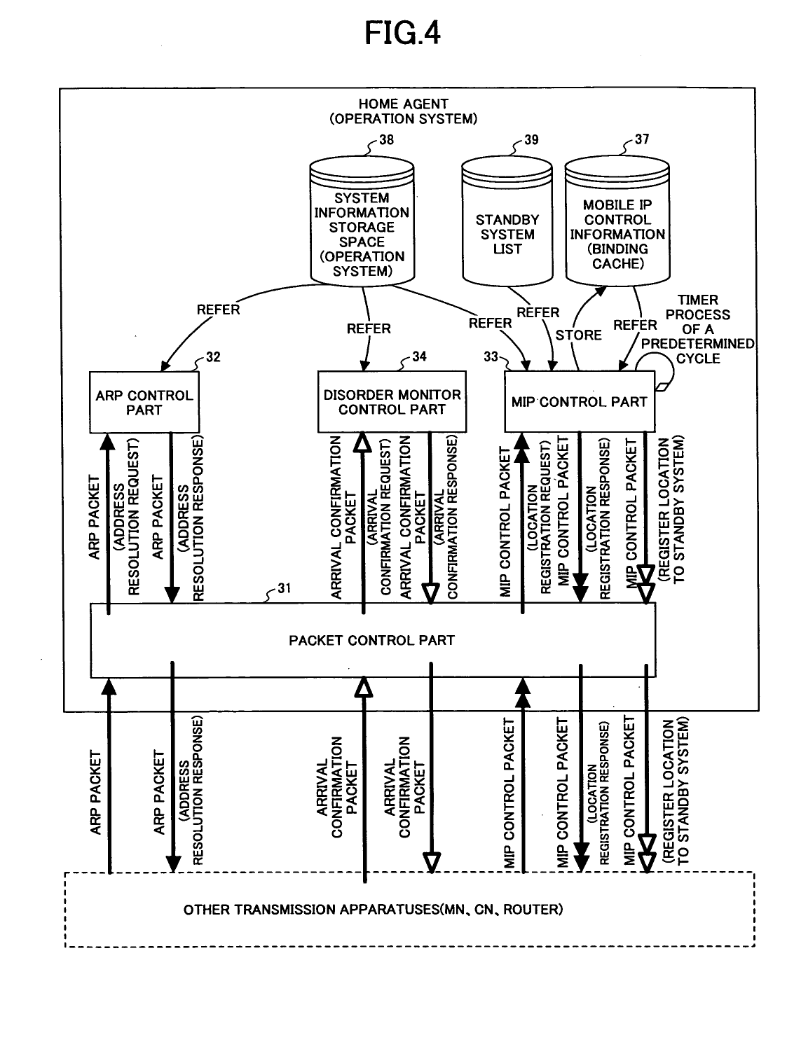

FIGS. 3 and 4 are block diagrams showing a standby system home agent, and an operation system home agent according to an embodiment of the present invention. It is to be noted that same components are denoted with same numerals in FIGS. 3 and 4. In FIG. 3 and 4, the home agent(s) include a packet control part 31 for controlling packet communication (sending/receiving), an ARP (Address Resolution Protocol) control part 32 for controlling ARP defined in the RFC (Request For Comments) as an address conversion protocol, an MIP control part 33 for conducting mobile IP control based on RFC 2002, RFC 3344, and a disorder monitor control part 34 for monitoring disorder in the home agent itself or that of other home agents.

The standby system home agent 100 shown in FIG. 3 includes, for example, a system information storage space 35 for the standby system, an operation system list 36 for storing respective IP addresses of the operation system home agents, and mobile IP control information (binding cache) 37. The operation system home agent 200 shown in FIG. 4 includes, for example, a system information storage. space 38 for the operation system, a standby system list 39 for storing the IP address of the standby system home agent, and the mobile IP control information (binding cache) 37.

The packet control part 31 includes functions of: receiving packets from other transmission apparatuses connected to the home link 21 (e.g. router 22); determining the types of received packets and allocating the received packets; transferring the allocated received packets to upper level control parts (e.g. the ARP control part 32, the MIP control part 33, and the disorder monitor control part 34); accepting packet transmission requests from the upper level control parts; and transmitting packets to other transmission apparatuses connected to the network.

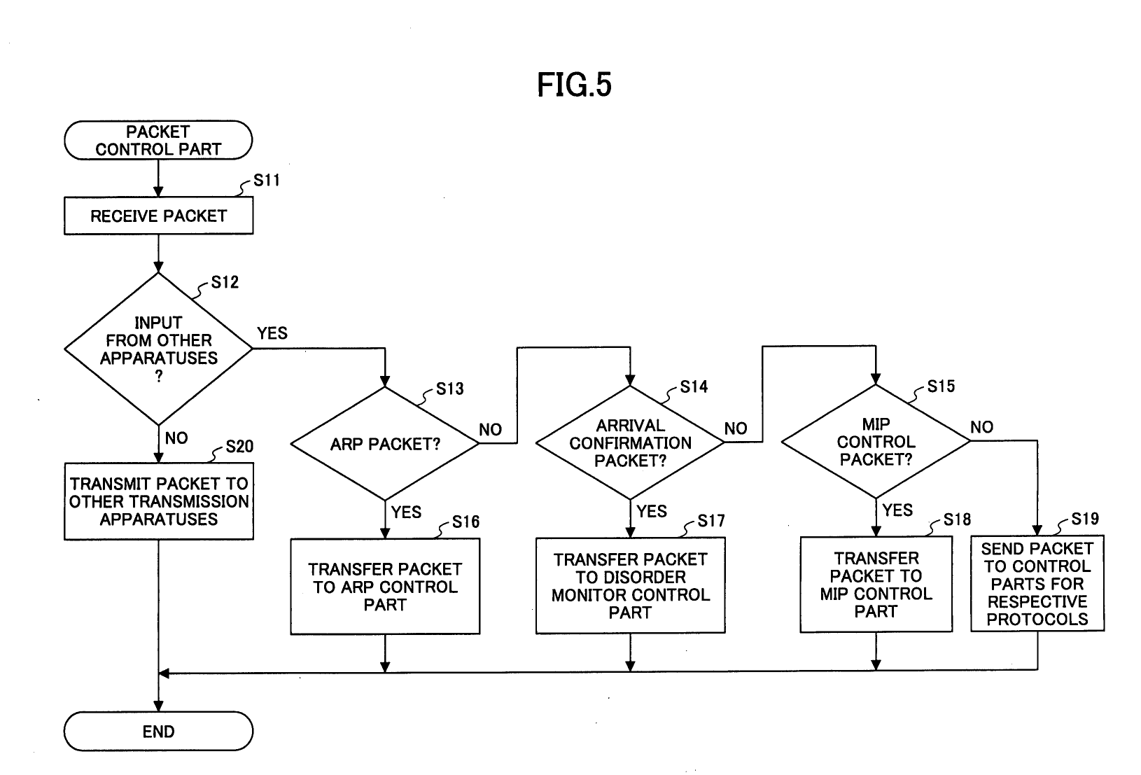

FIG. 5 is a flowchart showing a process executed by the packet control part 31. In FIG. 5, when the packet control part 31 receives a packet(s) (Step S11), the packet control part 31 determines the input origin of the packet, that is, determines whether the input (received) packet is from the other transmission apparatuses (Step S12). If the received packet is from the other transmission apparatuses (YES in Step S12), the packet control part 31 determines header information of the received packet, that is, determines whether the received packet is an ARP packet, a disorder monitor packet (arrival confirmation packet), or an MIP control packet (Steps S13-S15). If the received packet is the ARP packet (YES in Step S13), the packet control part 31 transfers the received packet to the ARP control part 32 (Step S16). If the received packet is the disorder monitor packet (YES in Step S14), the packet control part 31 transfers the received packet to the disorder monitor control part 34. If the received packet is the MIP control part 33 (YES in Step S15), the packet control part 31 transfers the received packet to the MIP control part 33. If the received packet is other than the above-described packets, the packet control part 31 transfers the received packet to control part(s) for respective protocols (Step S19). It is to be noted the control parts of respective protocols are not shown in FIGS. 3 and 4.

Meanwhile, when the packet control part 31 accepts a packet transmission request from the upper level control part(s), the packet control part 31 transmits the received packet to the other transmission apparatuses, such as, mobile terminal 20, router 22 (Step S20).

The ARP control part 32 includes an ARP (Address Resolution Protocol) defined in RFC 826 function, and an extended address resolution function (an extended address resolution function part) for determining whether response transmission is necessary. The ARP control part 32 also includes a GARP (Gratuitous Address Resolution Protocol) function based on RFC 2002 for notifying the correspondence between the IP address and the MAC address to the other surrounding nodes, and a switching control function (switching control function part), so that a substitute packet receiving function can be set and/or released according to the results of the disorder monitoring.

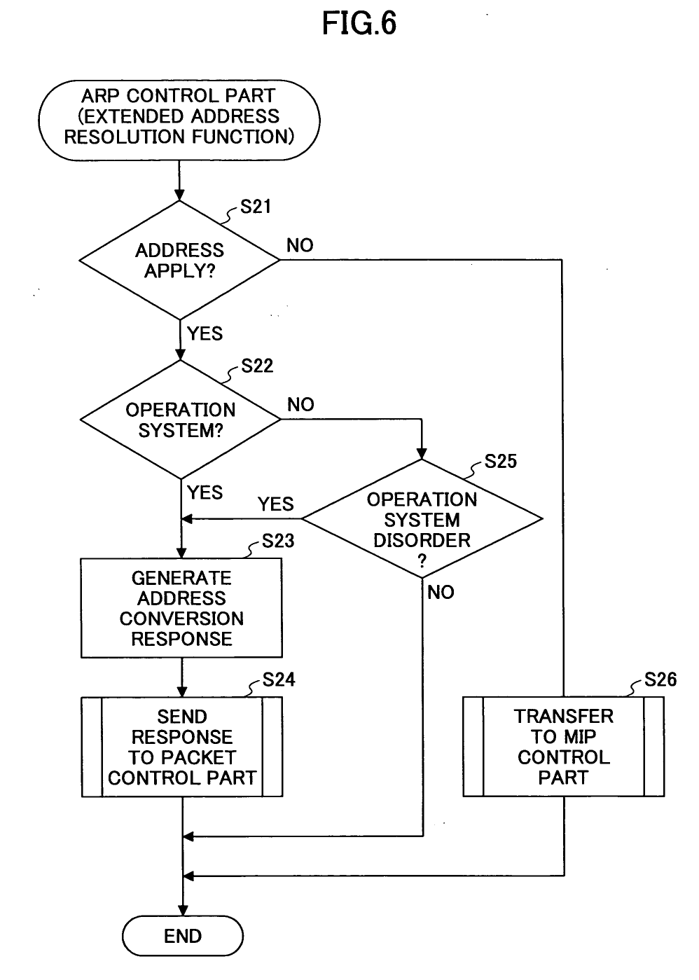

FIG. 6 is a flowchart for explaining the extended address resolution function (extended address resolution function part). In FIG. 6, the extended address resolution function part accepts an address conversion request from the packet control part 31. The extended address resolution function part determines whether the requested address information applies to that of the apparatus itself (Step S21), and also determines whether the apparatus itself is an operation system (Step S22). In a case where the requested address applies to that of the apparatus itself and where the apparatus itself is the operation system, the extended address resolution function part generates an address conversion response (Step S23), and sends the response to the packet control part 31 (Step S24).

In a case where the requested address applies to that of the apparatus itself and where the apparatus itself is a standby system (i.e. not an operation system), the extended address resolution function part does not generate and send an address conversion response since the standby system does not need to receive packets addressed to the operation system home agent(s). However, in a case where the extended address resolution function part determines that there is a disorder in the operation system (YES in Step 25), the extended address resolution function part generates the address conversion response (Step S23), and sends the response to the packet control part 31 (Step S24) for allowing the standby system home agent to receive packets addressed to the operation system home agent.

In a case where the requested address is not that of the apparatus itself (NO in Step S21), the requested address is transferred to the MIP control part 33 (Step S26) for conducting a binding cache recovery confirmation.

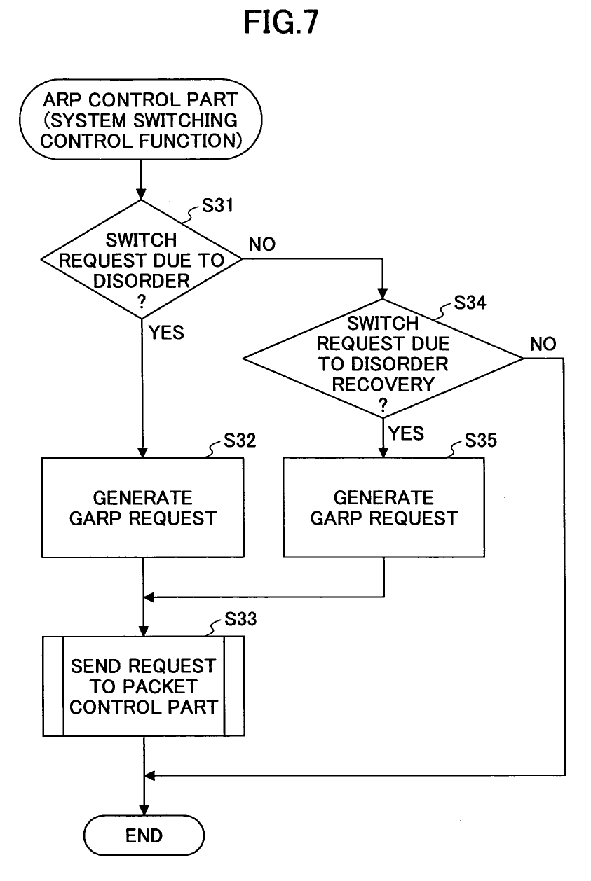

FIG. 7 is a flowchart showing a system switching control function (system switching control function part) according to an embodiment of the present invention. As shown in the flowchart, the system switching control function part determines whether the received switching request is generated due to disorder (Step S31). If the request is determined as a request due to disorder (as a notification of receipt from the disorder monitor control part 34) (YES in Step S31), the system switching control function part generates a GARP request for enabling its own apparatus (own home agent) to accept internet packets of the disordered system (Step S32), and transmits the GARP request to the packet control part 31 (Step S33).

Meanwhile, in a case where the switching request is not a switching request due to disorder, the system switching control function part determines whether the switching request is due to disorder recovery (Step S34). If the request is determined as a request due to disorder recovery (as a notification of receipt from the MIP control part 34) (YES in Step S34), the system switching control function part generates a GARP request for enabling the recovered system to accept internets packets being delivered to its own apparatus (own home agent), and transmit the GARP request to the packet control part 31 (Step S35).

In a case where the apparatus itself is an operation system, the MIP control part 33 includes a mobile IP control protocol function (defined in RFC 2002 and RFC 3344) and a mobile IP control protocol transfer function for transferring a location registration request(s) to the standby system.

In a case where the apparatus itself is a standby system, the MIP control part 33 includes a mobile IP control protocol transfer function, and a mobile IP control protocol reception standby function for not transmitting a location registration request response, after forming a binding cache, in accordance a location registration request transferred from the operation system.

The MIP control part 33 also includes a mobile IP control binding cache recovery function for enabling the recovered operation system to recover its binding cache maintained by the standby. system when the operation system recovers, and a mobile IP control binding cache recovery monitor function for monitoring the recovery of the binding cache of the operation system.

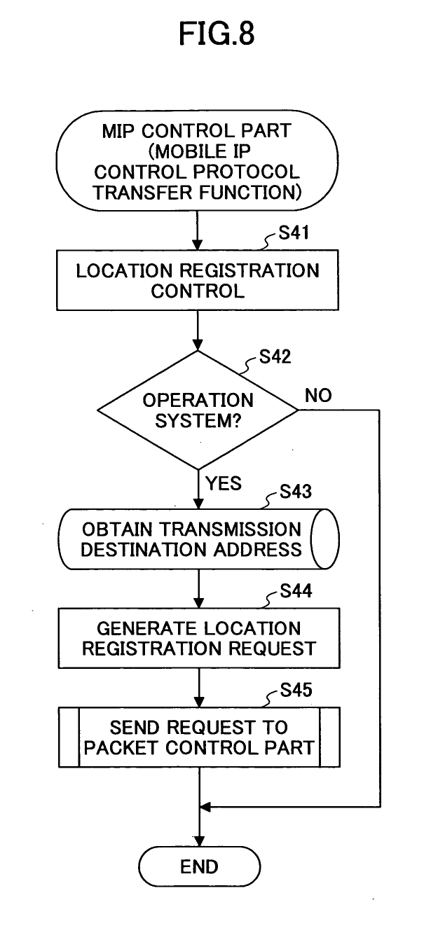

FIG. 8 is a flowchart showing a mobile IP control protocol transfer function (mobile IP control protocol transfer function part) of the MIP control part. With this function, a binding cache, which is the same as that of the operation system home agent, can be formed to the standby system home agent.

In the flowchart, the mobile IP control protocol transfer function part receives a location registration request from the packet control part 31 and conducts location registration control according to RFC 2002, RFC 3344 (here, location registration includes, for example, registration, update, and/or deletion of location) (Step S41). Then, the mobile IP control protocol transfer function part determined whether the apparatus itself is an operation system (Step S42). If the apparatus itself is an operation system (YES in Step S42), the mobile IP control protocol transfer function part obtains the address of the transmission origin from the standby system list (Step S43), generates a location registration request in accordance with the address (Step S44), and sends the generated request to the packet control part 31 to be transferred to the standby system (Step S45).

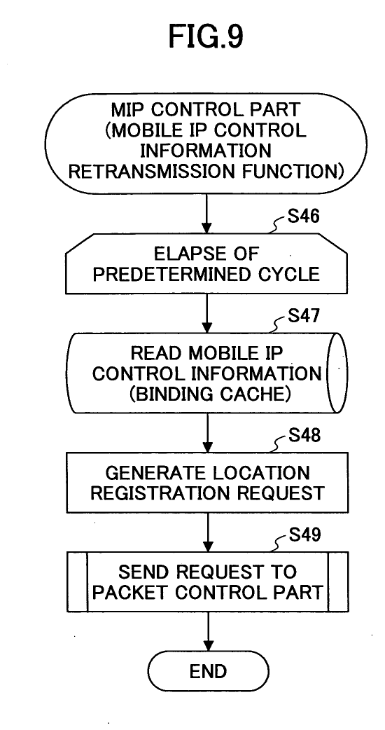

FIG. 9 is a flowchart showing a mobile IP control information retransmission function (mobile IP control information retransmission function part) of the MIP control part. This function is provided considering a case where the standby system home agent has not received a location registration request of a mobile terminal even though the operation system home agent transferred such request to the standby system home agent.

In the flowchart, whenever a prescribed cycle elapses (Step S46), the mobile IP control information retransmission function part reads mobile IP control information (binding cache) 37 maintained by the operation system home agent (Step S47) for synchronizing the binding cache maintained by the operation system home agent and the binding cache maintained by the standby system home agent. Then, the mobile IP control information retransmission function part generates a location registration request according to the read binding cache (Step S48), and sends the request to the packet control part 31 to be transmitted to the standby system home agent (Step S49).

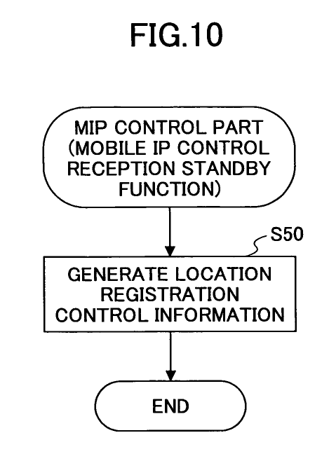

FIG. 10 is a flowchart showing a mobile IP control protocol reception standby function (mobile IP control protocol reception standby function part) of the MIP control part. In the flowchart, in a case where the standby system home agent received a location registration request from the operation system home agent, the mobile IP control protocol reception standby function part only generates location registration control information and a binding cache (Step S50), and does not respond to the location registration request. This is function is provided in order to prevent the standby system home agent from returning a response to the location registration request transferred from the operation system home agent to the standby system home agent, and preventing the mobile terminal from receiving two responses with respect to a single location registration request.

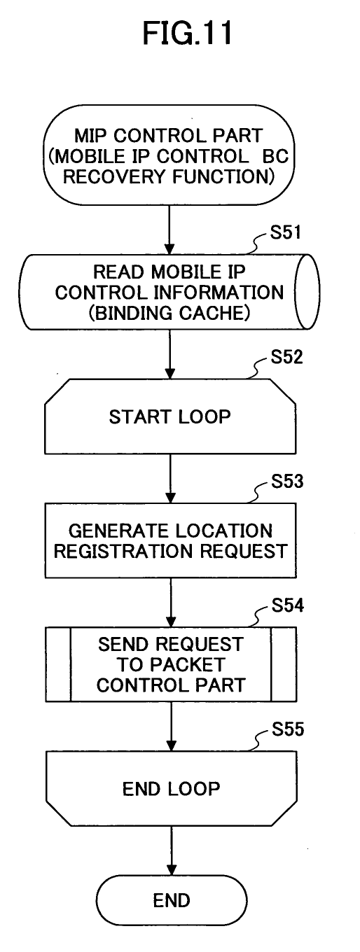

FIG. 11 is a flowchart showing a mobile IP control binding cache recovery function (mobile IP control binding cache recovery function part) of the MIP control part.

This function is conducted with the standby system, in which the binding cache, maintained by the standby system home agent during disorder of the operation system home agent, is provided to an operation system home agent that has recovered from the disorder.

In a case where the disorder monitor control part 34 detects recovery of the operation system, the mobile IP control binding cache recovery function part, upon receiving a request for transmittal of a location registration request, reads mobile IP control information (binding cache) (Step S51). After confirming the binding cache of the mobile terminal (MN) to be installed in the operation system home agent, a loop including the procedures of Steps S52 to S55 is executed in a number of times corresponding to the number of mobile terminals. In the loop, the mobile IP control binding cache recovery function part generates a location registration request with respect to one mobile terminal (Step S53), and sends the request to the packet control part 31 for transmission to the operation system (Step S54).

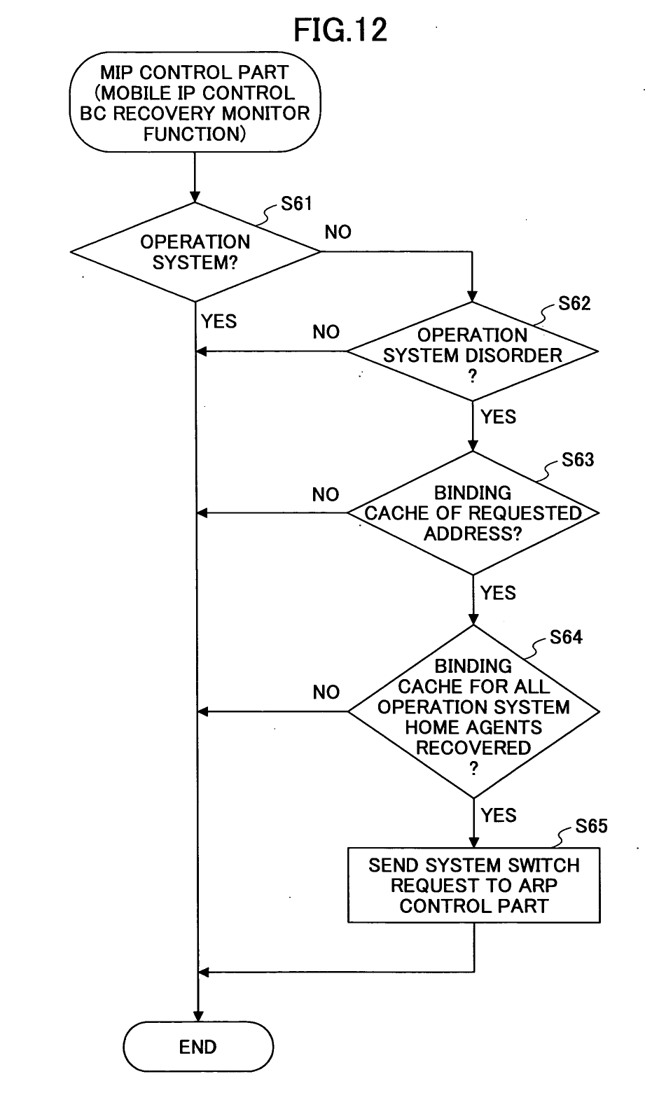

FIG. 12 is a flowchart showing a mobile IP control binding cache recovery monitor function (mobile IP control binding cache recovery monitor function part) of the MIP control part.

This function is conducted with the standby system for determining that the binding cache of all operation systems are recovered in a case of receiving a GARP request addressed to the mobile terminal from the ARP control part 32 of the operation system, wherein a system switch request is sent to the ARP control part 32 for switching systems with a GARP request after receiving GARP requests in a number corresponding to the number of mobile terminals requesting location registration as shown in FIG. 11.

In FIG. 12, the mobile IP control binding cache recovery monitor function part determines whether the apparatus itself (home agent itself) is a standby system home agent (Step S61). If the apparatus itself is a standby system home agent (NO in Step S61), it is determined whether the operation system is disordered (Step S62). If the operation system is disordered (YES in Step S62), it is determined whether there is a binding cache of the requested address (Step S63) for monitoring recovery of the operation system. If there is a binding cache(s) of the requested address (YES in Step S63), it is determined whether the binding caches of all operation system home agents are recovered (Step S64). If all of the binding caches of the operation system home agents are recovered, a system switch request is sent to the ARP control part 32 (Step S65).

The disorder monitor control part 34 shown in FIGS. 3 and 4 includes the following functions for enabling the standby system to monitor the operation state of the operation system: a disorder detection/switching function, a disorder recovery detection/switching function, an arrival confirmation response function, a disorder monitor packet transmission function, a disorder monitor packet reception function, and a disorder monitor timer control function. The disorder and/or disorder recovery are detected by detecting changes in the state of other home agents by periodically confirming the existence of the home agents in accordance with a arrival confirmation procedure (protocol not defined) performed on the home agents.

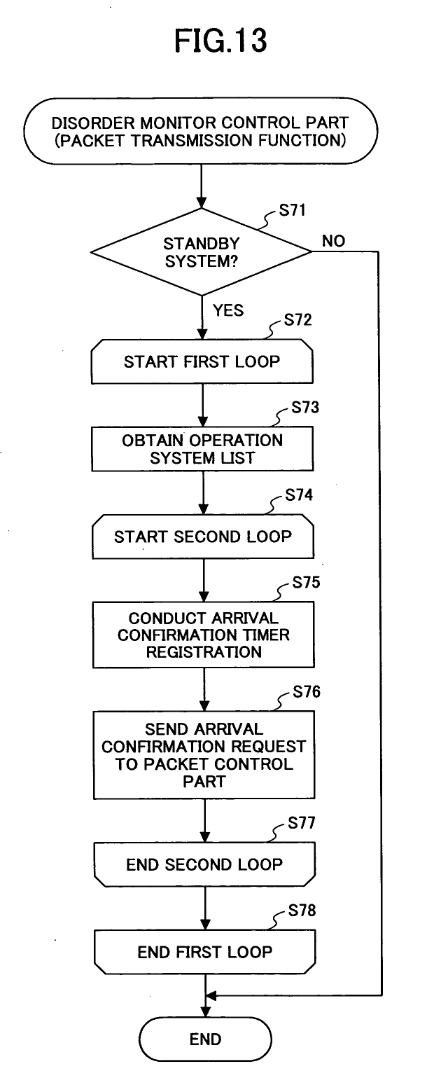

FIG. 13 shows a flowchart of a disorder monitor packet transmission function (disorder monitor packet transmission function part) of the disorder monitor control part. This function is provided for enabling standby system to confirm the operation state of the operation system, in which an arrival confirmation (e.g. ping) request is transmitted to the packet control part 31 after execution of arrival confirmation timer registration based on information of the operation system list.

In the flowchart, the disorder monitor packet transmission function part determines whether the apparatus itself (home agent itself) is a standby system (Step S71). If the apparatus itself is a standby system (YES in Step S71), a first loop including Steps S72 to S78 is started in a predetermined cycle (Step S72). The disorder monitor packet transmission function part obtains an operation system list 36 (Step S73), and starts a second loop including Steps S74 to S77 (Step S74). That is, the disorder monitor packet transmission function part executes a arrival confirmation timer registration (Step S75), and sends an arrival confirmation request (arrival confirmation packet ping) to the packet control part 31 (Step S76) for transmission to respective operation system home agents.

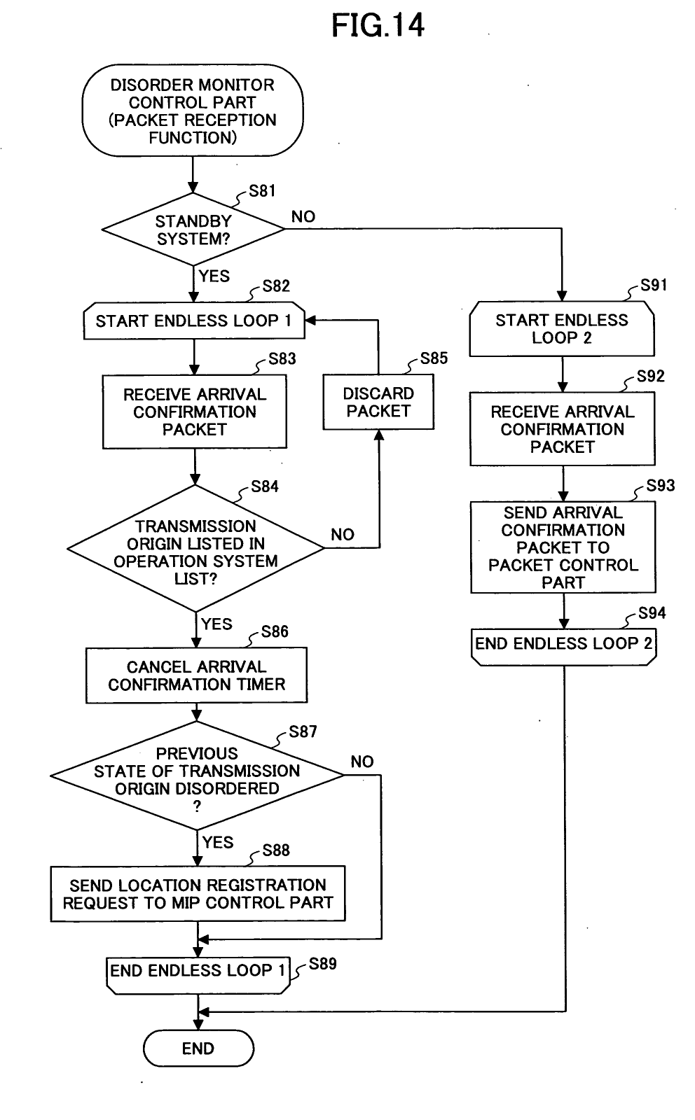

FIG. 14 is a flowchart showing a disorder monitor packet reception function (disorder monitor packet reception function part) of the disorder monitor control part. In the flowchart, the disorder monitor packet reception function part determines whether the apparatus itself (home agent itself) is a standby system home agent (Step S81). In a case where the apparatus itself is a standby system home agent (YES in Step S81), the disorder monitor packet reception function part starts an endless loop 1 including Steps S82 to S89 (Step S82). That is, the disorder monitor packet reception function part receives an arrival confirmation packet(s) from the packet control part 31 (Step S83), and determines whether the transmission origin is listed in the operation system list 36 (Step S84). In a case where the transmission origin is not listed in the operation system list 36 (NO in Step S84), the disorder monitor packet reception function part discards the arrival confirmation packet(s) (Step S85), and returns to Step S82.

In a case where the transmission origin is listed in the operation system list 36 (YES in Step S84), the disorder monitor packet reception function part cancels the arrival confirmation timer (Step S86). Then, the disorder monitor packet reception function part determines whether the previous state of the transmission origin is disordered (Step S87), in which the operation system is determined to be recovered only when the previous state of the transmission origin is disordered. The disorder monitor packet reception function part request the MIP control part 33 to transmit a location registration request (Step S88) for recovering the binding cache of the operation system.

Meanwhile, in a case where the apparatus itself is an operation system home agent (i.e. not a standby system home agent) (NO in Step S81), the disorder monitor packet reception function part starts an endless loop 2 including Steps S91 to S94 (Step S91). That is, the disorder monitor packet reception function part receives an arrival confirmation packet(s) from the packet control part 31 (Step S92), and sends the arrival confirmation packet to the packet control part 31 (Step S93) for transmission to the standby system home agent.

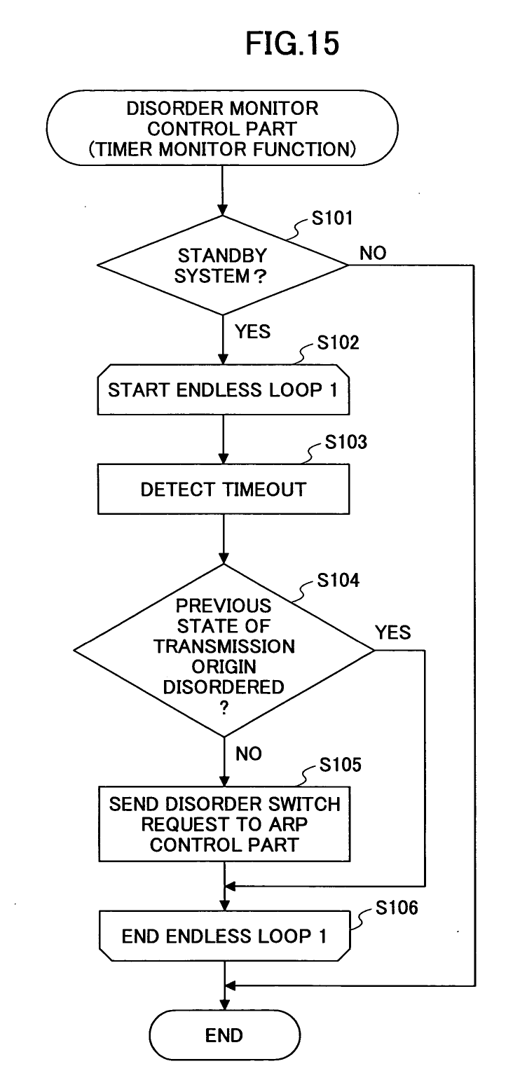

FIG. 15 is a flowchart showing a disorder monitor timer control function (disorder monitor timer control function part) of the disorder monitor control part. This function is employed upon generation of a timeout of the arrival confirmation timer that is set by the disorder monitor packet transmission function part. In FIG. 15, the disorder monitor timer control function determines whether the apparatus itself is a standby home agent (Step S101). Only in a case where the apparatus itself is a standby system home agent (YES in Step S101), the disorder monitor timer control function part executes an endless loop 1 including Steps S102 to S106 in a number of times corresponding to the number of list of the operation system list 36.

That is, the disorder monitor timer control function part detects timeout when no arrival confirmation packet(s) is received within an arrival confirmation period of a target apparatus (operation system home agent) (Step S103), and determines whether the previous state of the target apparatus is disordered (Step S104). Only when a timeout is detected for the first time in a case where the previous state of the target apparatus is not disordered, the disorder monitor timer control function part sends a disorder switch request to the ARP control part 32 (Step S105).

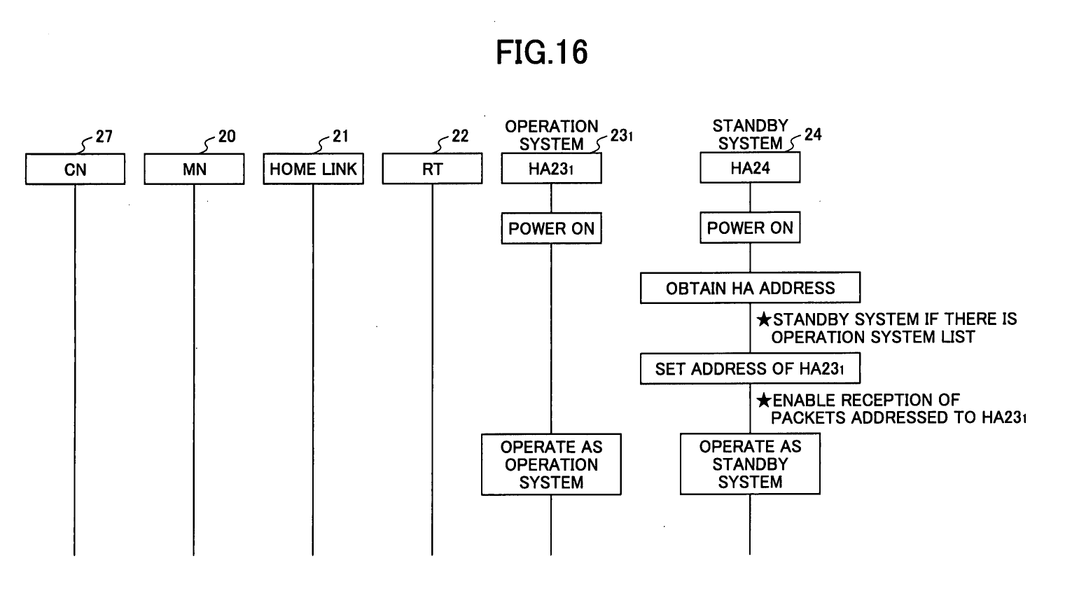

FIG. 16 is a schematic diagram showing an operation sequence for determining between operation system and standby system upon activation of the home agent. After the power of the home agent 23 is switched on, reading of an operation system list 36 for obtaining a home agent (HA) address is performed. However, since no operation system list 36 exists, the home agent operates as an operation system.

After the power of the home agent 24 is switched on, reading of an operation system list 36 is performed for obtaining a home agent (HA) address. Since an operation system list exists, the home agent 24 operates as a standby system. The home agent 24 sets the home agent address obtained from the operation system list 36 since the home agent 24 operates as the standby system, and enables reception of packets addressed to the home agent address.

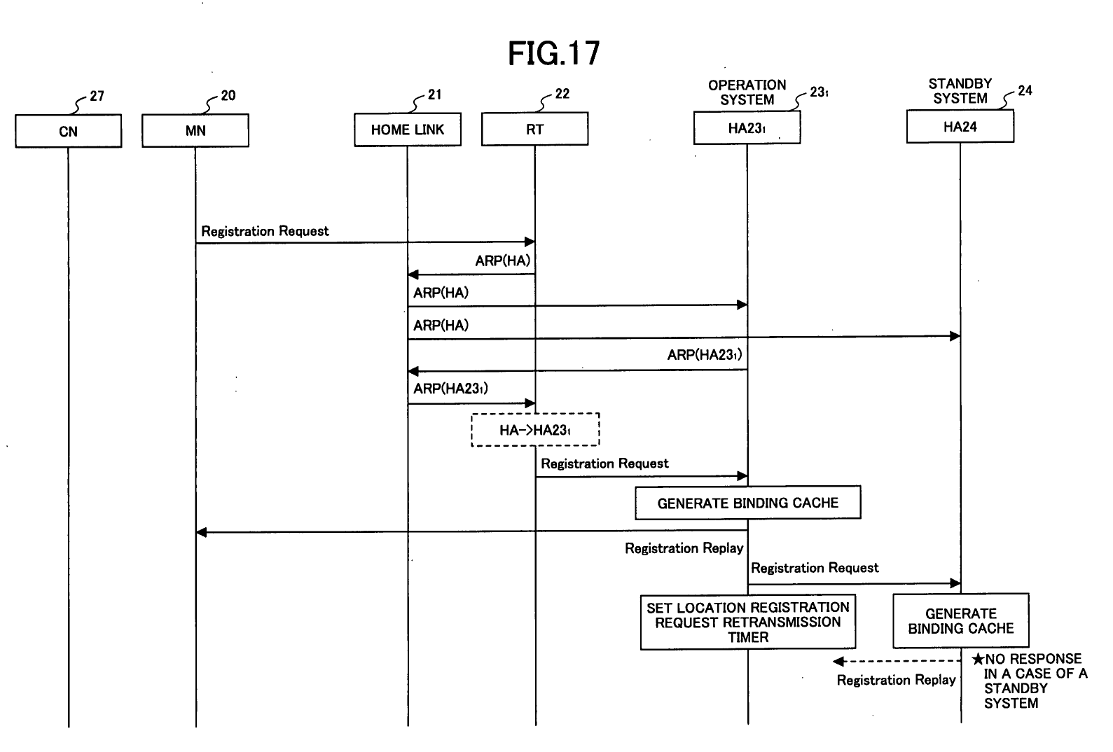

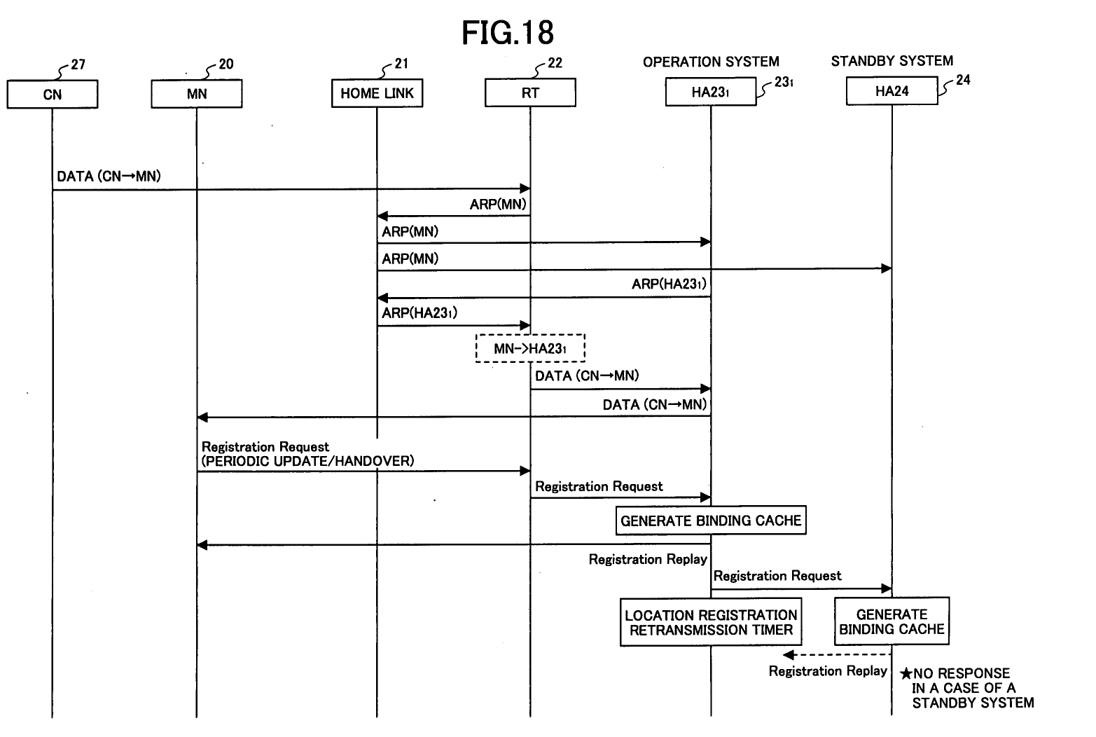

FIGS. 17 and 18 are schematic diagrams showing operation sequences in a case where an operation system home agent receives a location registration request from a mobile terminal. In FIG. 17, a location registration request (registration request) addressed to the home agent is transmitted from the mobile terminal 20. With IP routing, the packet(s) addressed to the home agent arrive at a router (RT) 22 neighboring the home agents 23₁, 24. The router 22 determines the destination node by performing ARP resolution on the location registration request addressed to the home agents.

Since the home agent 23 is an operation system, the response with respect to the ARP resolution from the router 22 is returned to the router 22 via the home link 21. The router 22, receiving the ARP response, transfers the location registration request addressed to the home agent to the home agent 23₁. The home agent 23₁, receiving the location registration request, generates a binding cache, and returns the location registration response to the mobile terminal 20.

Subsequently, the home agent 23₁ transfers the location registration request transmitted from the mobile terminal 20 to the standby home agent 24. After completing the transmission, the home agent 23₁ sets a location registration request retransmission timer. The standby system home agent 24, receiving the location registration request from the home agent 23₁, generates a binding cache which is the same as that of the home agent 23₁. The home agent 24 does not return a location registration response since the home agent 24 is operating as the standby system.

Next, as shown in FIG. 18, data packets addressed to the mobile terminal 20 is sent from the communication terminal (CN) to the router 22 neighboring the home agents 23₁, 24 according to IP routing. Since the home agent, maintaining the information binding cache for encapsulating the packets addressed to the mobile terminal 20, is the operation system, the home agent 23₁ returns an ARP response with respect to the packets addressed to the mobile terminal 20 to the router 22 via the home link 21.

The router 22, receiving the ARP response, transfers the packets addressed to the mobile terminal 20 to the home agent 23₁. The home agent 23₁, receiving the packets addressed to the mobile terminal 20, encapsulates the packets and transfers the encapsulated packets according to the binding cache. The transferred encapsulated packets arrive at the mobile terminal 20 according to IP routing.

Likewise, in a case where location registration request(s) from periodic update and handover is transmitted from the mobile terminal 20 to the home agent address (HA), the home agent 23₁ receives the location registration request and transfers the request to the home agent 24.

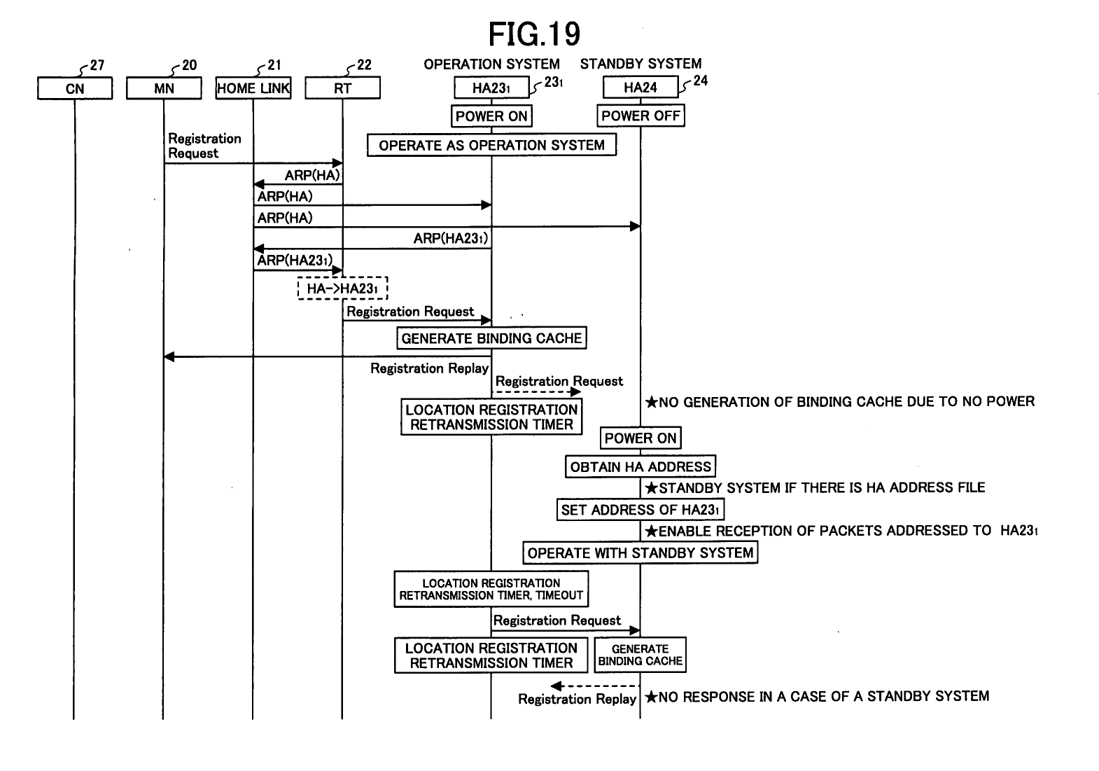

FIG. 19 is a schematic diagram showing an operation sequence for conforming the binding cache of the operation system home agent and that of the standby system home agent. In a case where the mobile terminal 20 transmits a location registration request addressed to a home agent when only the operation system home agent 23₁ is switched on (activated) , the home agent 23₁, after generating a binding cache (BC) according to the above described procedure of the location registration request, transfers the location registration request to the home agent 24, and sets the location registration request retransmission timer.

However, since the home agent 24 is not activated, the location registration request cannot be received, and the binding cache cannot be generated.

After the home agent 24 is activated as the standby system, the binding cache of the home agent 24 would not conform (match) with that of the since the binding cache generated in the home agent 23₁ is not generated in the home agent 24.

In a case where there is a timeout (e.g. a timeout for a few minutes) of the location registration request retransmission timer upon receiving the location registration request, the home agent 23₁ retransmits the location registration requests of all the mobile terminals generating binding caches to the standby system home agent 24 so as to attaining conformity between the binding cache of the home agent 23₁ and that of the standby system home agent 24.

Subsequently, the standby system home agent 24, receiving the location registration requests, generates a binding cache, to thereby obtain a binding which is the same as that of the home agent 23₁.

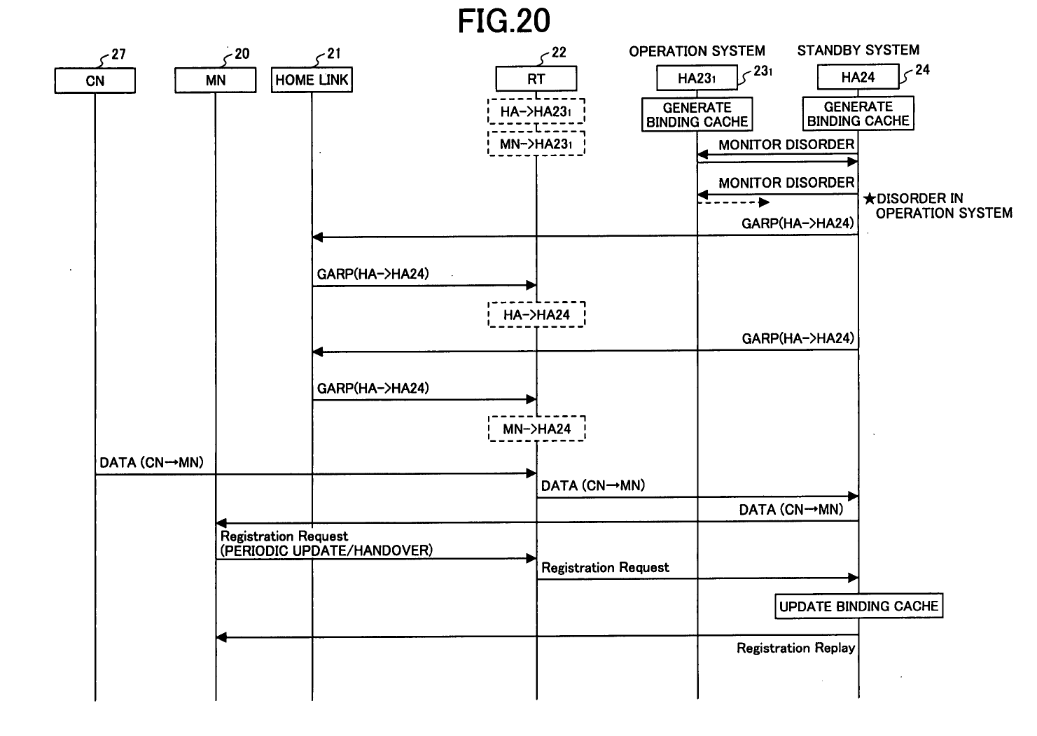

FIG. 20 is a schematic diagram showing a case where there is a disorder in the operation system. In a case where a disorder is detected in the operation system home agent 23₁ according to a periodic operation monitor procedure by the standby system home agent 24 under a state where both the standby system home agent 24 and the operation system home agent 23₁ maintain a binding cache, the standby system home agent 24 transmits GARP for rewriting the ARP cache (formed with an ARP resolution procedure) maintained by a neighboring router 22, to thereby transfers packets addressed to the home agent address (HA) and the mobile terminal 20.

The router 22, receiving the GARP, rewrites its ARP cache of the router, having a home agent (IP address) corresponding to the home agent 23₁ (MAC address) home agent and the mobile terminal 20 corresponding to the home agent 23₁ (MAC address), is rewritten in a manner where the home agent (IP address) corresponds to the home agent 24 and the mobile terminal 20 corresponds to the home agent 24 (MAC address).

Accordingly, the packets addressed to the mobile terminal 20 can be transferred from the communication terminal 27 to the home agent 24 via the home link 21 and the router 22, to thereby allow the home agent 24 to encapsulate and transfer the packets to the mobile terminal 20.

Furthermore, the packets addressed to the home agents (location registration requests) are transferred to the home agent 24 via the home link 21 and the router 22, and the home agent 24 continues to maintain its binding cache, to thereby continue communication between the communication terminal and the mobile terminal 20.

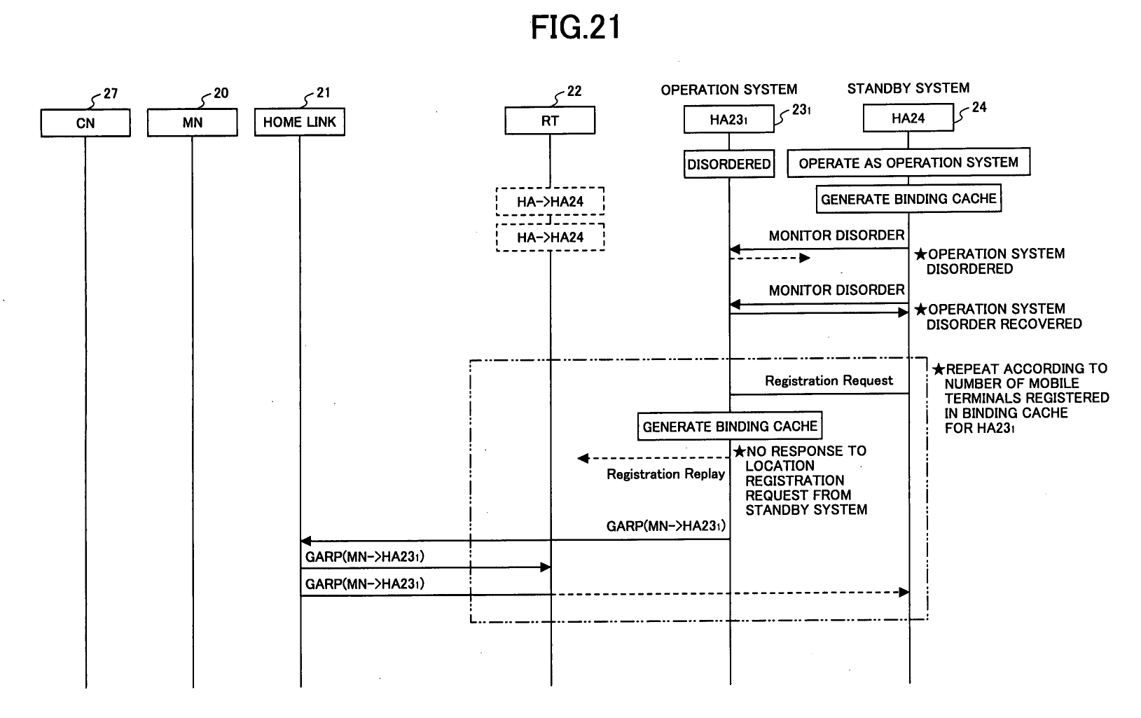

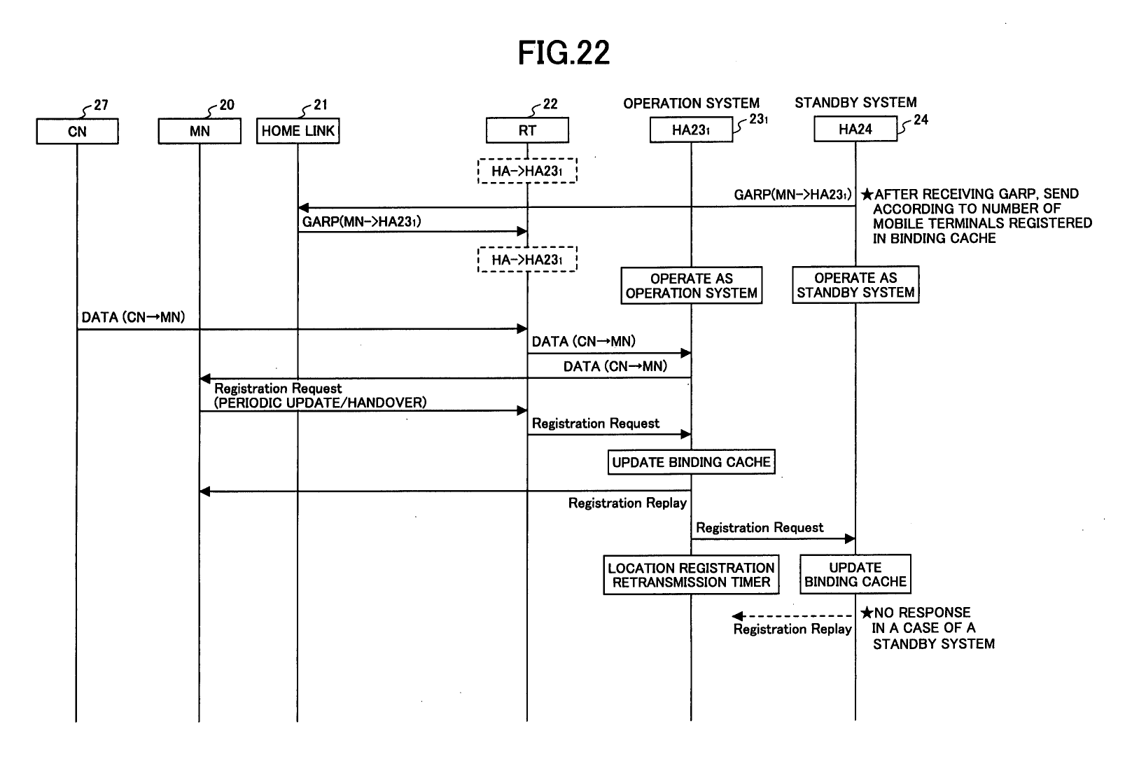

FIGS. 21 and 22 are schematic diagrams showing operation sequences in a case where the operation system recovers from disorder. When the standby system home agent 24 detects recovery of the operation system home agent 23₁ by monitoring operation of the operation system home agent 23₁, the standby system home agent 24 transmits location registration requests to the operation system home agent 23₁ in a number of times corresponding to the number of mobile terminals registered in the binding cache of the standby system home agent 24.

The operation system home agent 23₁, receiving the location registration requests, generates a binding cache transmits a GARP for rewriting the ARP cache maintained by a neighboring router 22, to thereby notify the router 22 to transfer packets addressed to the mobile terminal 20 to the operation system home agent 23₁. By receiving the GARP, the standby system home agent 24 determines that the location registration requests is properly sent to the operation system home agent 23₁ and that the binding cache is generated. However, the operation system home agent 23₁ does not return a response to the location registration requests from the standby system home agent 24.

In FIG. 22, after the GARPs (amounting to the total number mobile terminals) are transmitted from the operation system home agent 23₁ in response to the location registration requests transmitted (in a number corresponding to the number of mobile terminals registered in the binding cache of the standby system home agent) by the standby system home agent 24, the standby system home agent 24 transmits packets addressed to the home agent address to the neighboring router 22 so that the packets can be transferred to the operation system home agent 23₁.

Accordingly, packets addressed to the mobile terminal 20 are transferred from the communication terminal 27 to the operation system home agent 23₁ via the home link 21 and the router 22. The operation system home agent 23₁ encapsulates the packets and transfers the encapsulated packets to the operation system home agent 23₁.

In addition, location registration requests, which are also packets addressed to the operation system home agent 23₁, are also transferred to the operation system home agent 23₁ via the home link 21 and the router 22, and are maintained in the binding cache of the operation system home agent 23₁, thereby continuing communication between the communication terminal 27 and the mobile terminal 20.

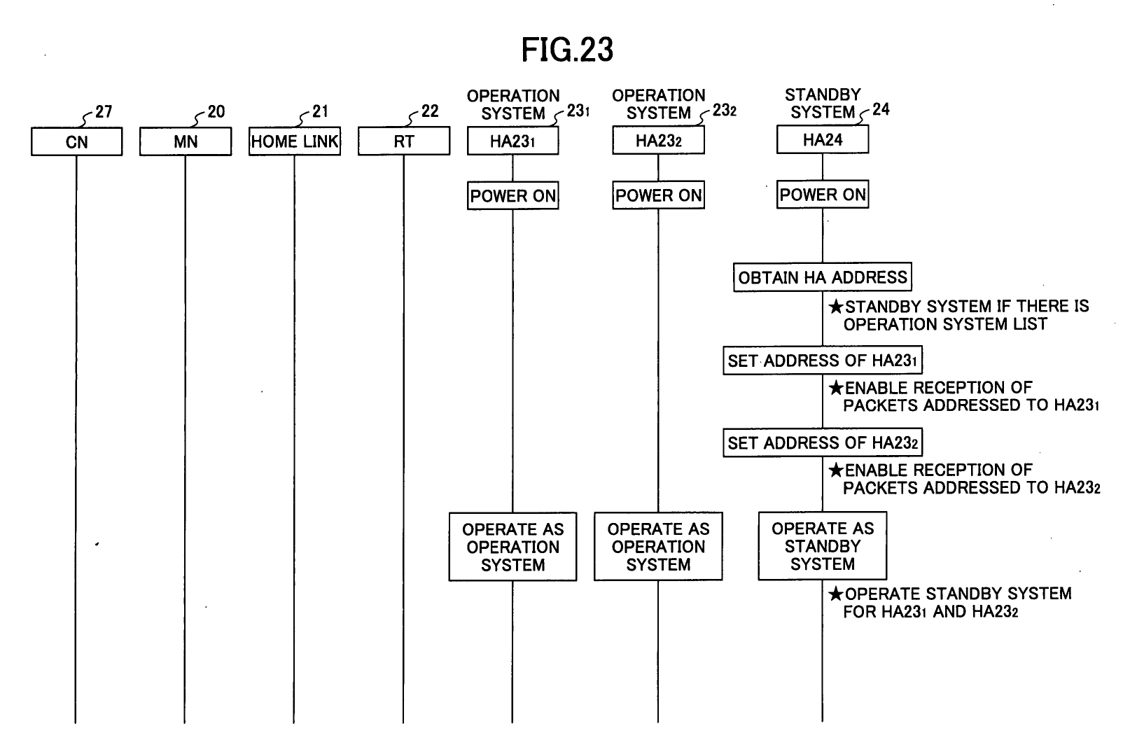

FIG. 23 is a schematic diagram showing an operation sequence in a case where a single standby system is provided with respect to plural operation systems. In FIG. 23, the home agents 23₁, 23₂ respectively operate as an operation system since there is no operation system list 36 to be read for obtaining a home agent address (HA).

The home agent 24 reads in finding the operation system list 36 for obtaining a home agent address. Since the operation system list 36 exists having plural home agent addresses listed thereto, the home agent 24 sets all of the home agent addresses for receiving all of the packets addressed to the home agent addresses. Subsequently, the operation described with FIGS. 17 to 22 is performed with respect to all of the home agent addresses.

In consequence, the present invention is able to achieve duplication of a home agent without requiring addition of a particular hardware. The home link can be provided in compliance to the mobile IP protocol control of RFC 2002 and RFC 3344. Furthermore, with the present invention, neither the mobile terminal nor the communication terminal is required to be subjected to a particular control due to a redundant configuration of the home agent. The home agent duplication configuration according to the present invention can be applied to a conventional mobile network.

The present invention ensures communication with mobile terminals without requiring any particular network configuration or hardware in a case of switching home agents due to home agent disorder. Accordingly, the present invention ensures network quality without requiring additional investment for equipment and the like. Since the duplication configuration according to the present invention does not require the standby system and the operation system to correspond on a one to one basis, the communication service provider may freely adjust the configuration to one system to N number of systems according to the investment cost and/or the required quality level.

Although the above-described example shown in Japanese Laid-Open Patent Application No. 10-512122 has a slave responding to a transferred message from a master, the present invention is different in that the standby system home agent does not respond to the transferred location registration request. Furthermore, although the above-described example shown in Japanese Laid-Open Patent Application No.2000-152315 uses a common line signal method for enhancing reliability of a health checkup, the present invention is different in that the standby system home agent monitors the operation system home agent by periodically sending an arrival confirmation request(s) to the operation system home agent. Furthermore, although the above-described example shown in Japanese Laid-Open Patent Application No.11-68780 applies mobile IP technology to an ATM network, the present invention is different in that the home agents are duplicated.

It is to be noted that the mobile IP control information 37 corresponds to an address correspondence maintaining unit, the packet control part 31 corresponds to a transferring unit (transmitting unit), the operation system list 36 corresponds to a home agent address maintaining unit, the MIP control part 33 corresponds to a sending unit and a no-responding unit, and the ARP control part 32 corresponds to a switching unit.

Further, the present invention is not limited to these embodiments, but various variations and modifications may be made without departing from the scope of the present invention.

The present application is based on Japanese priority application No.2004-076624 filed on Mar. 17, 2004, with the Japanese Patent Office, the entire contents of which are hereby incorporated by reference.

1. A method for duplicating a home agent including an address correspondence maintaining unit for maintaining a destination address of a mobile terminal in correspondence with a home address of the mobile terminal, and a transferring unit for encapsulating an IP packet addressed to the home address of the mobile terminal and transferring the encapsulated IP packet to the destination address of the mobile terminal, the method comprising the steps of:
setting a home agent address, which is the same as a home agent address of an operation system home agent, to a standby system home agent; and
receiving a location registration request, which is sent from the mobile terminal and addressed to the operation system home agent, with the standby system home agent.

2. The method as claimed in claim 1, further comprising the steps of:
generating a corresponding relation between the destination address of the mobile terminal and the home address of the mobile terminal with the standby system home agent, the generated corresponding relation having the same content as the corresponding relation of the operation system home agent;
maintaining the generated corresponding relation in an address correspondence maintaining unit of the standby system home agent; and
returning no response from the standby system home agent with respect to the location registration request sent from the mobile terminal.

3. The method as claimed in claim 2, further comprising a step of:
periodically transmitting location registration requests registered in an address correspondence maintaining unit of the operation system home agent to the standby system home agent.

4. The method as claimed in claim 3, further comprising the steps of:
monitoring an operation state of the operation system home agent; and
switching a transmission destination from the operation system home agent to the standby system home agent when a disorder of the operation system home agent is detected from monitoring the operation state of the operation system home agent, so that packets addressed to the home address and the operation system home agent are transferred to the standby system home agent.

5. The method as claimed in claim 4, further comprising the steps of:
transmitting location registration requests registered in the address correspondence maintaining unit of the standby system home agent to the operation system home agent when a recovery of the disorder of the operation system home agent is detected from monitoring the operation state of the operation system home agent;
generating another corresponding relation between the destination address of the mobile terminal and the home address of the mobile terminal with the operation system home agent, the other generated corresponding relation having the same content as the corresponding relation of the standby system home agent;
maintaining the generated corresponding relation in the address correspondence maintaining unit of the standby system home agent; and
returning no response from the operation system home agent with respect to the location registration request sent from the mobile terminal.

6. The method as claimed in claim 5, further comprising a step of:
switching a transmission destination from the standby system home agent to the operation system home agent when completing the transmission of the location registration requests from the standby system home agent to the operation system home agent after detecting the recovery of the disorder of the operation system home agent, so that packets addressed to the home address and the operation system home agent are transferred to the operation system home agent.

7. The method as claimed in claim 1, further comprising a step of:
setting another home agent address, which is the same as another home agent address of another operation system home agent, to the standby system home agent.

8. A standby system home agent used for a method for duplicating a home agent including an address correspondence maintaining unit for maintaining a destination address of a mobile terminal in correspondence with a home address of the mobile terminal, and a transferring unit for encapsulating an IP packet addressed to the home address of the mobile terminal and transferring the encapsulated IP packet to the destination address of the mobile terminal, the standby system home agent comprising:
a home agent address maintaining unit for maintaining a home agent address which is the same as a home agent of an operation system agent,
wherein the standby system home agent receives a location registration request which is sent from the mobile terminal and addressed to the operation system home agent.

9. The standby system home agent as claimed in claim 8, further comprising a no response unit for generating a corresponding relation between the destination address of the mobile terminal and the home address of the mobile terminal, the generated corresponding relation having the same content as the corresponding relation of the operation system home agent, for maintaining the generated corresponding relation in an address correspondence maintaining unit of the standby system home agent, and for returning no response with respect to the location registration request sent from the mobile terminal.

10. The standby system home agent as claimed in claim 9, further comprising a switching unit for switching a transmission destination from the operation system home agent to the standby system home agent when a disorder of the operation system home agent is detected from monitoring an operation state of the operation system home agent, so that packets addressed to the home address and the operation system home agent are transferred to the standby system home agent.

11. The standby system home agent as claimed in claim 10, further comprising a transmitting unit for transmitting location registration requests registered in the address correspondence maintaining unit of the standby system home agent to the operation system home agent when a recovery of the disorder of the operation system home agent is detected from monitoring the operation state of the operation system home agent.

12. The standby system home agent as claimed in claim 11, wherein the switching unit switches a transmission destination from the standby system home agent to the operation system home agent when completing the transmission of the location registration requests from the standby system home agent to the operation system home agent after detecting the recovery of the disorder of the operation system home agent, so that packets addressed to the home address and the operation system home agent are transferred to the operation system home agent.

13. An operation system home agent used for a method for duplicating a home agent including an address correspondence maintaining unit for maintaining a destination address of a mobile terminal in correspondence with a home address of the mobile terminal, and a transferring unit for encapsulating an IP packet addressed to the home address of the mobile terminal and transferring the encapsulated IP packet to the destination address of the mobile terminal, the operation system home agent comprising:
a transmitting unit for periodically transmitting location registration requests registered in an address correspondence maintaining unit of the operation system home agent to the standby system home agent.

14. The operation system home agent as claimed in claim 13, further comprising a no response unit for receiving location registration requests registered in the address correspondence maintaining unit of the standby system home agent from the standby system home agent, for generating a corresponding relation between the destination address of the mobile terminal and the home address of the mobile terminal, the generated corresponding relation having the same content as the corresponding relation of the standby system home agent, for maintaining the generated corresponding relation in the address correspondence maintaining unit of the standby system home agent, and for returning no response with respect to the location registration request sent from the mobile terminal.
